(19) United States
(12) Patent Application Publication
(10) Pub. No.: US 2014/0090387 A1
(43) Pub. Date: Apr. 3, 2014

(54) FUEL HEATING SYSTEM FOR A POWER PLANT AND METHOD OF HEATING FUEL

(71) Applicant: GENERAL ELECTRIC COMPANY, Schenectady, NY (US)

(72) Inventors: Joseph John, Bangalore (IN); Veerappan Muthaiah, Bangalore (IN); Chandrasekhar Pushkaran, Bangalore (IN); Prithviraj Pandian, Bangalore (IN)

(73) Assignee: GENERAL ELECTRIC COMPANY, Schenectady, NY (US)

(21) Appl. No.: 13/633,689

(22) Filed: Oct. 2, 2012

(51) Int. Cl. F02C 7/08

(52) U.S. Cl. 60/772; 60/736

(57) ABSTRACT

A fuel heating system for a power plant includes an exhaust structure having an interior region for receiving an exhaust gas therein. Also included is a fluid injection arrangement comprising a first fluid duct for transferring a fluid, the first fluid duct extending at least partially throughout the interior region of the exhaust structure for heating the fluid. Further included is a heat exchanger for receiving the fluid and a liquid fuel, the fluid heating the liquid fuel during passage of the liquid fuel through the heat exchanger.

### BACKGROUND OF THE INVENTION

The subject matter disclosed herein relates to power plants, and more particularly to a fuel heating system for such power plants, as well as a method of heating fuel within a power plant.

Power plants may include a gas turbine system having at least one combustor and a turbine section, among other sections. Such a power plant also may include a water injection system employed for emission control by injecting the water into the at least one combustor. The water is typically injected into the at least one combustor at or near ambient temperature. Additionally, the power plant includes a fuel injection system, with one such arrangement configured to accommodate liquid fuel for injection into the at least one combustor. Prior to combustor injection, the liquid fuel is typically heated by one or more electric heaters to achieve and maintain a desired viscosity. Unfortunately, the one or more heaters are relatively costly and also require substantial power consumption to adequately operate.

### BRIEF DESCRIPTION OF THE INVENTION

According to one aspect of the invention, a fuel heating system for a power plant includes an exhaust structure having an interior region for receiving an exhaust gas therein. Also included is a fluid injection arrangement comprising a first fluid duct for transferring a fluid, the first fluid duct extending at least partially throughout the interior region of the exhaust structure for heating the fluid. Further included is a heat exchanger for receiving the fluid and a liquid fuel, the fluid heating the liquid fuel during passage of the liquid fuel through the heat exchanger.

According to another aspect of the invention, a fuel heating system for a power plant includes a turbine section having an exhaust outlet for expelling an exhaust gas. Also included is a first heat exchanger in operable connection with the exhaust outlet for receiving the exhaust gas, the first heat exchanger also receiving a fluid from a fluid injection arrangement, wherein the fluid is heated by the exhaust gas therein. Further included is a second heat exchanger configured to receive a liquid fuel, the second heat exchanger in operable connection with the first heat exchanger for receiving the fluid subsequent to heating by the exhaust gas in the first heat exchanger, the fluid heating the liquid fuel within the second heat exchanger.

According to yet another aspect of the invention, a method of heating fuel for a power plant is provided. The method includes heating a fluid with an exhaust gas of a turbine section of the power plant. Also included is routing the fluid heated by the exhaust gas to a heat exchanger. Further included is routing a liquid fuel to the heat exchanger from a liquid fuel supply. Yet further included is heating the liquid fuel with the fluid within the heat exchanger.

These and other advantages and features will become more apparent from the following description taken in conjunction with the drawings.

### BRIEF DESCRIPTION OF THE DRAWINGS

The subject matter, which is regarded as the invention, is particularly pointed out and distinctly claimed in the claims at the conclusion of the specification. The foregoing and other features, and advantages of the invention are apparent from the following detailed description taken in conjunction with the accompanying drawings in which:

FIG. 1 is a schematic illustration of a power plant having a fuel heating system according to a first embodiment;

FIG. 2 is a plot illustrating water injection temperatures within the fuel heating system as a function of power plant load at various ambient temperatures;

FIG. 3 is a schematic illustration of the power plant having the fuel heating system according to a second embodiment; and

FIG. 4 is a flow diagram illustrating a method of heating fuel within the power plant.

The detailed description explains embodiments of the invention, together with advantages and features, by way of example with reference to the drawings.

### DETAILED DESCRIPTION OF THE INVENTION

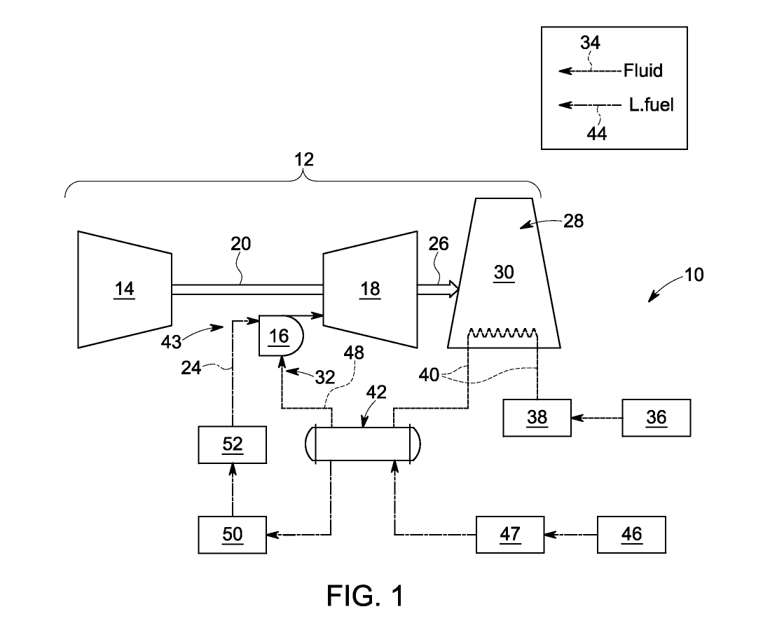

Referring to FIG. 1, a power plant according to a first embodiment is schematically illustrated and generally referred to with numeral 10. The power plant 10 includes a turbine system, such as a gas turbine system 12 having a compressor section 14, a combustor section 16, a turbine section 18 and a rotor 20. It is to be appreciated that one embodiment of the gas turbine system 12 may include a plurality of compressors 14, combustors 16, turbines 18 and rotors 20. The compressor section 14 and the turbine section 18 are coupled by the rotor 20. The rotor 20 comprises a single shaft or a plurality of shaft segments coupled together to form the rotor 20.

The combustor section 16 uses a combustible fuel, such as a liquid fuel, to run the gas turbine system 12. For example, fuel nozzles are in fluid communication with a main flow exiting the compressor 14 and a liquid fuel supply line 24. The fuel nozzles create an air-fuel mixture, and discharge the air-fuel mixture into the combustor section 16, thereby causing a combustion that creates a hot pressurized exhaust gas. The combustor section 16 directs the hot pressurized gas through a transition piece into a turbine nozzle (or “stage one nozzle”), and other stages of buckets and nozzles causing rotation of turbine blades within an outer casing of the turbine section 18. A hot exhaust gas 26 is expelled from the turbine section 18 into an exhaust structure 28, such as an exhaust bypass or exhaust stack. The exhaust structure 28 includes an interior region 30 configured to receive the hot exhaust gas 26, the temperature of which may vary, and in an exemplary embodiment the temperature of the hot exhaust gas 26 exceeds about 800° F. (about 427° C.).

The power plant 10 includes a fluid injection arrangement 32 configured to inject a fluid, such as a water 34, into the combustor section 16 at a high pressure. Although an exemplary embodiment of the fluid comprises water, it is contemplated that other fluids may be employed. The water 34 is converted to steam in the combustor section 16 which provides desirable emission control, such as NOx reduction. The water 34 is provided by a fluid supply 36, such as a demineralized water storage tank, to a fluid injection skid 38 having numerous components therein for manipulating the water 34. The components may include pumps and filters, for example. The fluid injection arrangement 32 includes a first fluid duct 40 that transfers the water 34 from the water injection skid 38 into and through at least a portion of the interior region 30 of the exhaust structure 28. During transfer through at least a portion of the interior region 30, the first fluid duct 40, and therefore the water 34, is exposed to the hot exhaust gas 26. The exposure to the hot exhaust gas 26 heats the water 34 from a first temperature to a second temperature. The first temperature of the water 34, measured prior to entry of the water 34 to the interior region 30 of the exhaust structure 28, is typically about ambient temperature, which may correspond to about 70° F. (about 21° C.) in many environments, but it is understood that the first temperature is dependent upon the ambient conditions. The second temperature of the water 34, measured subsequent to exit of the water 34 from the interior region 30 of the exhaust structure 28, is greater than the first temperature and is dependent upon load conditions of the gas turbine system 12, as well as the ambient conditions which determine a saturation temperature of the water 34.

Subsequent to heating within the exhaust structure 28, the water 34 is transferred to a heat exchanger 42. The heat exchanger 42 is in communication with a liquid fuel injection arrangement 43 and is configured to receive a liquid fuel 44 from a liquid supply 46 via the liquid fuel supply line 24. Prior to entry of the liquid fuel 44 into the heat exchanger 42, the liquid fuel 44 is directed through a liquid fuel forwarding skid 47 having numerous components therein for manipulating the liquid fuel 44. The components may include pumps and filters, for example. The liquid fuel 44 is heated within the heat exchanger 42 by the water 34 that has been heated by the hot exhaust gas 26 in the exhaust structure 28, as described in detail above. Heating of the liquid fuel 44 is necessary to achieve a viscosity of the liquid fuel 44 suitable for injection to the combustor section 16. The liquid fuel 44 may rise to and from various temperatures through the heat exchanger 42, and in one exemplary embodiment the temperature rises from about 80° F. (about 27° C.) to about 180° F. (about 82° C.). Both the liquid fuel 44 and the water 34 are directed from the heat exchanger 42 to the combustor section 16. The liquid fuel 44 may be directed along the liquid fuel supply line 24 through one or more components, such as a liquid fuel selection skid 50 and/or a liquid fuel atomizing air skid 52. Ultimately, the liquid fuel 44 is directed to the combustor section 16.

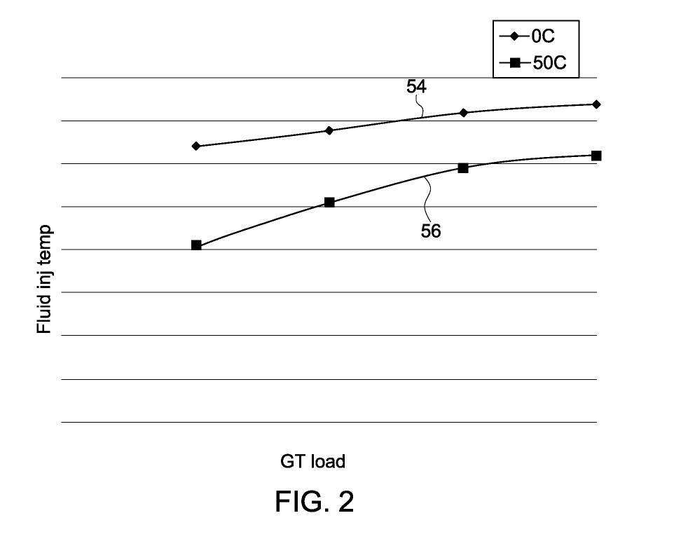

In the case of the water 34, a second fluid duct 48 may be employed to route the water 34 to the combustor section 16, with the water 34 having cooled slightly as a result of losses attributed to heating of the liquid fuel 44. It is to be appreciated that the second fluid duct 48 may simply be an extension of the first fluid duct 40. The injection temperature of the water 34 to the combustor section 16 is dependent upon the ambient conditions, as noted above, with the saturation temperature providing an upper limit on the injection temperature. Two injection temperature profiles at different ambient temperatures are illustrated in FIG. 2. It is shown that as the gas turbine operating load increases, the fluid injection temperature increases due to a higher temperature of the hot exhaust gas 26 present for heating of the water 34. The plot illustrates a first temperature profile 54 for about 32° F. (about 0° C.) and a second temperature profile 56 for about 122° F. (about 50° C.).

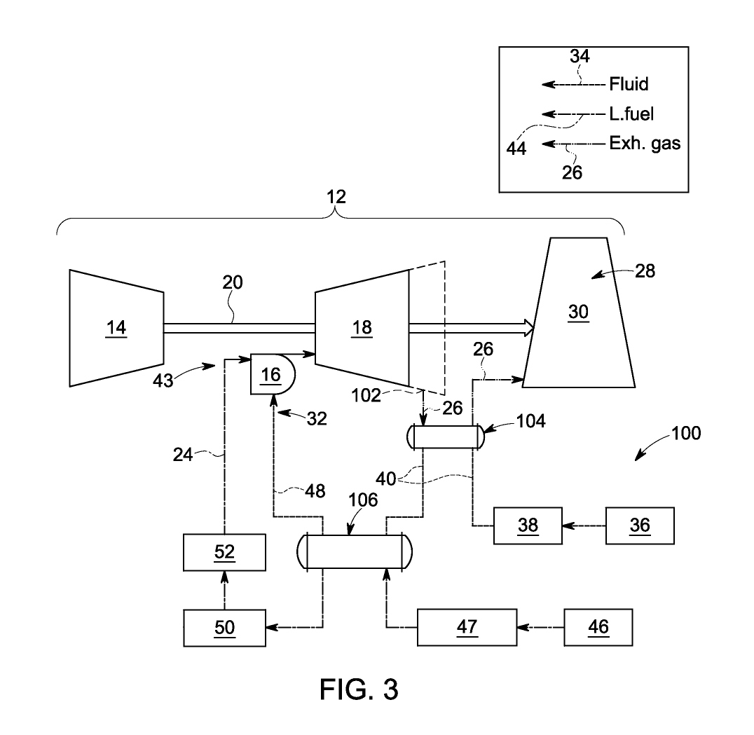

Referring now to FIG. 3, a power plant according to a second embodiment is schematically illustrated and generally referred to with numeral 100. The second embodiment of the power plant 100 is similar in many respects to that of the first embodiment, such that each component need not be discussed in further detail or repetitively. Where applicable, similar reference numerals used to describe the first embodiment may be employed. Rather than expelling all of the hot exhaust gas 26 to the exhaust structure 28, the turbine section 18 directs at least a portion of the hot exhaust gas 26 through an exhaust outlet 102 to a first heat exchanger 104 disposed at an external location to that of the turbine section 18 and the exhaust structure 28. The first heat exchanger 104 is also configured to receive the water 34 at about ambient temperature from the fluid supply 36 via the fluid injection skid 38. The water 34 is heated by the hot exhaust gas 26 during passage through the first heat exchanger 104. As discussed above with respect to the first embodiment, the exit temperature of the water 34 is limited by the saturation temperature which is dependent upon ambient conditions. The hot exhaust gas 26 is then expelled from the first heat exchanger 104 to the exhaust structure 28 or to the environment.

Subsequent to heating within the first heat exchanger 104, the water 34 is transferred to a second heat exchanger 106. The second heat exchanger 106 is in communication with the liquid fuel injection arrangement 43 and is configured to receive the liquid fuel 44 from the liquid supply 46 via the liquid fuel supply line 24, similar to the heat exchanger 42 of the first embodiment. The remaining components and operations are similar to that of the first embodiment. Specifically, the liquid fuel 44 is heated by the water 34 within the second heat exchanger 106 to achieve a viscosity suitable for injection to the combustor section 16. As described in detail above, both the water 34 and the liquid fuel 44 are then routed to the combustor section 16.

Advantageously, both the first and second embodiments of the power plant 10, 100 provide an efficient system for heating the water 34 and the liquid fuel 44. Additionally, heating of the water 34 to a temperature greater than ambient temperature provides greater efficiency of overall power plant performance, based on the reduced latent heat consumed in the combustor section 16 during heating of the water for emissions control. Overall, equipment and operation costs are decreased, while efficiency of the power plant 10, 100 is increased.

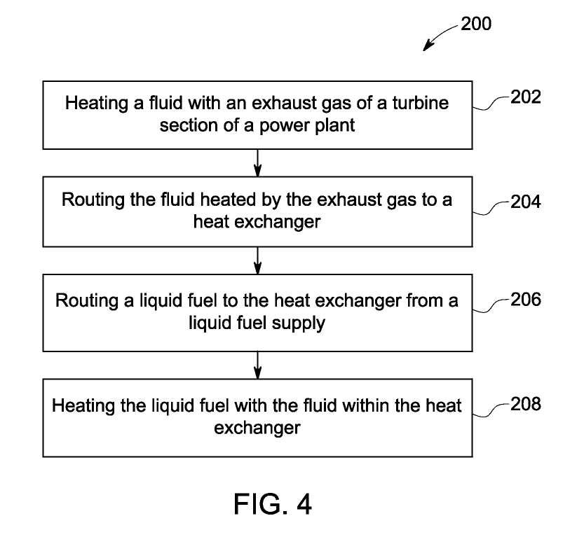

As illustrated in the flow diagram of FIG. 4, and with reference to FIGS. 1-3, a method of heating fuel for a power plant 200 is also provided. Both the first and second embodiments of the power plant 10, 100 have been previously described and specific structural components need not be described in further detail. The method of heating fuel for a power plant 200 includes heating a fluid with an exhaust gas of a turbine section of the power plant 202. The fluid is routed to a heat exchanger 204. A liquid fuel is also routed to the heat exchanger from a liquid fuel supply 206, wherein the liquid fuel is heated by the fluid within the heat exchanger 208.

While the invention has been described in detail in connection with only a limited number of embodiments, it should be readily understood that the invention is not limited to such disclosed embodiments. Rather, the invention can be modified to incorporate any number of variations, alterations, substitutions or equivalent arrangements not heretofore described, but which are commensurate with the spirit and scope of the invention. Additionally, while various embodiments of the invention have been described, it is to be understood that aspects of the invention may include only some of the described embodiments. Accordingly, the invention is not to be seen as limited by the foregoing description, but is only limited by the scope of the appended claims.

1. A fuel heating system for a power plant comprising:
an exhaust structure having an interior region for receiving an exhaust gas therein;
a fluid injection arrangement comprising a first fluid duct for transferring a fluid, the first fluid duct extending at least partially throughout the interior region of the exhaust structure for heating the fluid; and
a heat exchanger for receiving the fluid and a liquid fuel, the fluid heating the liquid fuel during passage of the liquid fuel through the heat exchanger.

2. The fuel heating system of claim 1, wherein the fluid comprises water.

3. The fuel heating system of claim 1, further comprising a second fluid duct for transferring the fluid from the heat exchanger to a combustor.

4. The fuel heating system of claim 1, further comprising a liquid fuel injection arrangement for receiving the liquid fuel from the heat exchanger and transferring the liquid fuel to a combustor.

5. The fuel heating system of claim 1, wherein the exhaust gas is expelled from a turbine section of the power plant to the exhaust structure.

6. The fuel heating system of claim 1, wherein the fluid enters the interior region of the exhaust structure at a first temperature and exits the interior region of the exhaust structure at a second temperature, the second temperature being greater than the first temperature.

7. The fuel heating system of claim 6, wherein the first temperature is about 70 degrees Fahrenheit.

8. The fuel heating system of claim 6, wherein the second temperature is less than a saturation temperature for the fluid.

9. A fuel heating system for a power plant comprising:
a turbine section having an exhaust outlet for expelling an exhaust gas;
a first heat exchanger in operable connection with the exhaust outlet for receiving the exhaust gas, the first heat exchanger also receiving a fluid from a fluid injection arrangement, wherein the fluid is heated by the exhaust gas therein; and
a second heat exchanger configured to receive a liquid fuel, the second heat exchanger in operable connection with the first heat exchanger for receiving the fluid subsequent to heating by the exhaust gas in the first heat exchanger, the fluid heating the liquid fuel within the second heat exchanger.

10. The fuel heating system of claim 9, wherein the fluid comprises water.

11. The fuel heating system of claim 9, further comprising a combustor for receiving the fluid from the second heat exchanger.

12. The fuel heating system of claim 9, further comprising a liquid fuel injection arrangement for receiving the liquid fuel from the second heat exchanger and transferring the liquid fuel to a combustor.

13. The fuel heating system of claim 9, further comprising an exhaust structure for receiving the exhaust gas from the first heat exchanger.

14. The fuel heating system of claim 9, wherein the fluid enters the first heat exchanger at a first temperature and exits the first heat exchanger at a second temperature, the second temperature being greater than the first temperature.

15. The fuel heating system of claim 14, wherein the first temperature is about 70 degrees Fahrenheit.

16. The fuel heating system of claim 14, wherein the second temperature is less than a saturation temperature for the fluid.

17. A method of heating fuel for a power plant comprising:
heating a fluid with an exhaust gas of a turbine section of the power plant;
routing the fluid heated by the exhaust gas to a heat exchanger;
routing a liquid fuel to the heat exchanger from a liquid fuel supply; and
heating the liquid fuel with the fluid within the heat exchanger.

18. The method of claim 17, wherein heating the fluid occurs within an interior region of an exhaust structure configured to receive the exhaust gas from the turbine section.

19. The method of claim 17, wherein heating the fluid occurs within a fluid heat exchanger configured to receive the exhaust gas from an exhaust outlet of the turbine section.

20. The method of claim 17, further comprising routing the fluid and the liquid fuel from the heat exchanger to a combustor.
